(19) United States
(12) Patent Application Publication
(10) Pub. No.: US 2026/0312981 A1
(43) Pub. Date: Oct. 8, 2026

(54) SECURITY ATTACK MITIGATOR FOR AUTOMOTIVE DYNAMIC SECURITY DEFENSE LEVELS

(71) Applicant: Red Hat, Inc., Raleigh, NC (US)

(72) Inventors: Paolo Antinori, Milan (IT); Andrea Cosentino, Milan (IT)

(21) Appl. No.: 19/170,951

(22) Filed: Apr. 4, 2025

(51) Int. Cl. H04L 9/40

(52) U.S. Cl. CPC H04L 63/1433; H04L 63/1425; H04L 63/20

(57) ABSTRACT

Aspects of the present disclosure relate to a security attack mitigator for automotive dynamic security defense levels. More specifically, a processing device obtains an indication of a security risk to a vehicle. The processing device identifies, via a rules engine, a security rule from amongst a plurality of security rules based on the indication of the security risk to the vehicle, where the security rule indicates a mitigation strategy for the security risk. The processing device implements, at the vehicle, the mitigation strategy indicated by the security rule.

### TECHNICAL FIELD

Aspects of the present disclosure relate to vehicle security, and more particularly, to a security attack mitigator for automotive dynamic security defense levels.

### BACKGROUND

A vehicle (e.g., an automobile) may include different computing systems that perform different functions within the vehicle. For example, an automobile may include embedded systems (e.g., electronic control units (ECUs)) that control electrical systems or subsystems of the automobile. Example ECUs may include an engine control module (ECM), a powertrain control module (PCM), a transmission control module (TCM), a brake control module (BCM), a central control module (CCM), a central timing module (CTM), a general electronic module (GEM), a body control module, and/or a suspension control module (SCM).

A vehicle (e.g., an automobile) may be a connected vehicle. A connected vehicle refers to a vehicle that is capable of communicating with entities outside of the vehicle and/or inside of the vehicle via a wired connection and/or a wireless connection. In an example, the entities may be or include a user device (e.g., a smartphone) of a user inside or outside of the vehicle, other vehicles, cloud platform, and/or a roadside unit (RSU). A connected vehicle may provide services to passengers (e.g., music services) based on communicating with the entities. A connected vehicle may also support or enhance self-driving functionality as well. A connected vehicle may be capable of vehicle-to-everything (V2X) communications. V2X communications may include vehicle-to-infrastructure (V2I) communications, vehicle-to-vehicle (V2V) communications, vehicle-to-cloud (V2C) communications, vehicle-to-pedestrian (V2P) communications, vehicle-to-device (V2D) communications, vehicle-to-network (V2N) communications, and/or vehicle-to-grid (V2G) communications.

### BRIEF DESCRIPTION OF THE DRAWINGS

The described aspects and the advantages thereof may best be understood by reference to the following description taken in conjunction with the accompanying drawings. These drawings in no way limit any changes in form and detail that may be made to the described aspects by one skilled in the art without departing from the spirit and scope of the described aspects.

FIG. 1 is a block diagram that illustrates an example of a vehicle in accordance with some aspects of the present disclosure.

FIG. 2 is a block diagram that illustrates an example system in accordance with some aspects of the present disclosure.

FIG. 3 is a flow diagram of a method for security attack mitigation for automotive dynamic security defense levels in accordance with some aspects of the present disclosure.

FIG. 4 is a block diagram of an example of a computer system that may perform one or more of the operations described herein in accordance with some aspects of the present disclosure.

### DETAILED DESCRIPTION

As indicated above, a vehicle (e.g., a land-based vehicle, such as an automobile) may include embedded systems (e.g., ECUs) that control systems (i.e., vehicle systems) or subsystems (i.e., vehicle subsystems) of the vehicle. In an example, an automobile may include one-hundred and fifty ECUs that work to control different systems and/or subsystems of the automobile. Furthermore, a vehicle that includes ECUs may be a connected vehicle that is capable of communicating with entities outside of the vehicle and/or inside of the vehicle via a wired connection and/or a wireless connection. As such, a vehicle may be viewed as a collection of computing devices that work to provide different functionality for the vehicle. For instance, the functionality may include navigating the vehicle, providing entertainment services to occupants of the vehicle, controlling a climate inside the vehicle, etc.

As a connected vehicle may be exposed to different entities via the Internet (or another network), ECUs of the vehicle may be at risk for potential cyberattacks much like other non-vehicle based computing devices. In an example, a cyberattack may originate via communication(s) received by the vehicle from entities outside of the vehicle (e.g., a denial-of-service (DoS) attack) or from a compromised device connected to the vehicle (e.g., a smartphone of a driver of the vehicle carrying malware). Some approaches for mitigating cyberattacks to a vehicle may not be well-tailored to the severity of a cyberattack. If a mitigation strategy for a cyberattack is too heavy-handed, operation of the vehicle may be disrupted and/or excessive computing resources of the vehicle may be utilized to address the cyberattack; however, if the mitigation strategy for the cyberattack is not strong enough, the vehicle may be at risk. Moreover, some approaches for mitigating cyberattacks may not take into account certain safety standards (e.g., functional safety (FuSa)) and/or may not take into account operational realities of the vehicle. For instance, if a mitigation strategy for a cyberattack is to turn off an engine of the vehicle and receive a software update, and the vehicle is currently travelling on a highway at a high velocity, it may not be feasible to perform the mitigation strategy.

The present disclosure addresses the above-noted and other deficiencies by using a processing device to implement a security attack mitigator for automotive dynamic security defense levels. In an example, the processing device may detect a cyberattack (i.e., a security risk) and evaluate a level of the cyberattack according to defined security levels. The processing device may utilize the level of the cyberattack to identify, via a rules engine, a security rule in a list of security rules. The processing device may then implement a mitigation strategy (e.g., rate-limiting, disabling an ECU, disabling a feature of the ECU, etc.) indicated by the security rule. In some aspects, the rule may include metadata that facilitates conformance with a standard (e.g., FuSa) and/or a flag that facilitates the mitigation strategy being implemented within a limited time window. In some aspects, the processing device may identify and/or execute a security rule based on a triggering event (e.g., during service of the vehicle).

In an example, a processing device obtains an indication of a security risk to a vehicle. The processing device identifies, via a rules engine, a security rule from amongst a plurality of security rules based on the indication of the security risk to the vehicle, where the security rule indicates a mitigation strategy for the security risk. The processing device implements, at the vehicle, the mitigation strategy indicated by the security rule.

As discussed herein, the present disclosure provides an approach that improves the operation of a computer system by reducing an amount of computing resources used to mitigate a cyberattack (or a potential cyberattack) through a selective implementation of a security rule that is tailored to address the cyberattack. For instance, vis-á-vis identifying a security rule from amongst a plurality of security rules based on the indication of the security risk to the vehicle and implementing a mitigation strategy indicated by the security rule, a computing system of the vehicle may conserve computing resources. Furthermore, as discussed herein, the present disclosure provides an approach that improves the technological field of automotive security by preventing embedded systems (e.g., ECUs) of a vehicle from being compromised or making the embedded systems less likely to be compromised. For instance, vis-á-vis identifying a security rule from amongst a plurality of security rules based on the indication of the security risk to the vehicle and implementing a mitigation strategy indicated by the security rule, the embedded systems of the vehicle may be prevented from being compromised or the embedded systems of the vehicle may be less likely to be compromised.

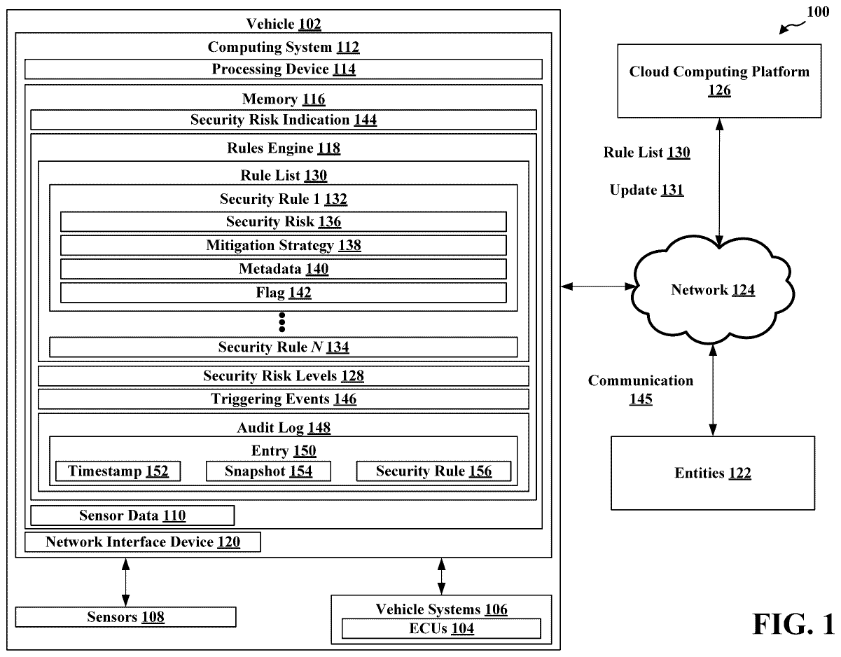

FIG. 1 is a block diagram 100 that illustrates an example of a vehicle 102 in accordance with some aspects of the present disclosure. In an example, the vehicle 102 may be or include a land-based vehicle, a sea-based vehicle, an air-based vehicle, and/or a space-based vehicle. In an example, a land-based vehicle may be or include a car, a truck, a train, a bus, and/or a motorcycle. In an example, a sea-based vehicle may be or include a boat and/or a submarine. In an example, an air-based vehicle may be or include a plane, a helicopter, and/or a drone. The vehicle 102 may be a non-autonomous vehicle (i.e., a vehicle that requires human input to operate), a semi-autonomous vehicle (i.e., a vehicle that is capable of performing certain functionality without human input), or an autonomous vehicle (i.e., a vehicle that is able to operate without human input). In some aspects, a non-autonomous vehicle may refer to level zero of the Society of Engineers (SAE) levels of autonomous driving. Level zero of the SAE levels of autonomous driving refers to a vehicle in which a driver is responsible for all aspects of driving, even when enhanced by warning and/or intervention levels. In some aspects, a semi-autonomous vehicle may refer to level one, level two, level three, or level four of the SAE levels of autonomous driving. Level one of the SAE levels of autonomous driving refers to a vehicle that can assist with either steering (e.g., lane-keeping assist) or acceleration/deceleration (e.g., adaptive cruise control), but not both simultaneously. Level two of the SAE levels of autonomous driving refers to a vehicle that can assist with both steering and acceleration/deceleration, but the driver remains in control and is ready to take over operation of the vehicle at any moment. Level three of the SAE levels of autonomous driving refers to a vehicle that can handle most driving tasks under specific conditions, but the driver is ready to take over when requested by the vehicle. Level four of the SAE levels of autonomous driving refers to a vehicle that can handle all driving tasks under specific conditions, and the driver is not actively involved in driving tasks. In some aspects, an autonomous vehicle may refer to level five of the SAE levels of autonomous driving. Level five of the SAE levels of autonomous driving refers to a vehicle that can handle all driving tasks in all conditions without any human intervention.

The vehicle 102 may include ECUs 104. An ECU (which may also be referred to as an electronic control module) may refer to an embedded system (i.e., a specialized computer system that has a dedicated function within a larger system) in automotive electronics that controls one or more vehicle systems or vehicle subsystems in a car or other motor vehicle. In an example, the ECUs 104 may be or include a generic powertrain, a door control unit (DCU), an engine control unit, an electric power steering control unit (PSCU), a human-machine interface (HMI), a powertrain control module (PCM), a seat control unit, a speed control unit (SCU), a telematic control unit (TCU), a transmission control module (TCM), a brake control module, a battery management system (BMS), a central timing module (CTM), a general electronic module, a body control module, a suspension control module, a central control module, and/or a module associated with information and/or entertainment within the vehicle 102. Some or all of the ECUs 104 may communicate with one another or other computing devices via various interfaces. In an example, an ECU in the ECUs 104 may include a core (e.g., a microcontroller), memory (e.g., static random-access memory (SRAM), electrically erasable programmable read-only memory (EEPROM), flash memory, etc.), inputs (e.g., supply voltage and ground, digital inputs, analog inputs), outputs (e.g., actuator drivers, H bridge drivers for servomotors, logic outputs), communication links (e.g., housing, bus transceivers), and embedded software (e.g., a boot loader, metadata for ECU and software identification, version management, checksums, functional software routines, and configuration data).

The vehicle 102 may include vehicle systems 106. Each vehicle system in the vehicle systems 106 may be responsible for providing certain functionality to the vehicle 102. In an example, the vehicle systems 106 may be or include an engine system, a transmission system, an exhaust system, a fuel system, a braking system, a suspension system, a steering system, a drive train, an electrical system, a light system, a radio system, an air conditioning system, a heating system, an airbag system, a seatbelt system, an anti-lock braking system, a vehicular communication system, a navigation system, an information system, and/or an entertainment system.

Each vehicle system in the vehicle systems 106 may be associated with (e.g., integrated with, coupled to, in communication with, controlled by, etc.) one or more ECUs in the ECUs 104. In an example, a first vehicle system in the vehicle systems 106 may be associated with (e.g., integrated with, coupled to, in communication with, controlled by, etc.) a first ECU in the ECUs 104 and a second vehicle system in the vehicle systems 106 may be associated with (e.g., integrated with, coupled to, in communication with, controlled by, etc.) a second ECU in the ECUs 104. In some aspects, an ECU in the ECUs 104 may be associated with (e.g., integrated with, coupled to, in communication with, controlled by, etc.) more than one vehicle system in the vehicle systems 106.

The vehicle 102 may include sensors 108 that generate sensor data 110 that enable the vehicle to determine characteristics of an environment in which the vehicle 102 is located. In an example, the sensors 108 may be or include camera(s), video camera(s), radar sensor(s), light detection and ranging (LIDAR) sensor(s), and/or sound navigation and ranging (SONAR) sensor(s). In an example, the sensor data 110 may be or include camera images, video data, radar data, LIDAR data (e.g., point clouds), and/or SONAR data. In some aspects, the sensors 108 may include a global navigation satellite system (GNSS) module that enables the vehicle 102 to determine a location (e.g., a latitude and longitude) of the vehicle 102.

The vehicle 102 may include a computing system 112. In an example, the computing system 112 may be or include the computer system 400 (or a portion thereof). The computing system 112 may be communicatively coupled to the ECUs 104, the vehicle systems 106, and/or the sensors 108. In some aspects, the computing system 112 may be or include an ECU, such as a central control module.

The computing system 112 may include a processing device 114 (e.g., a processor, such as one or more central processing units (CPUs), one or more graphics processing units (GPUs), etc.) and memory 116 (e.g., random access memory (RAM)). The memory 116 may store a rules engine 118 (i.e., computer-executable instructions) that, when executed by the processing device 114, causes the processing device 114 to implement functionality pertaining to a security attack mitigator for automotive dynamic security defense levels as described herein.

The computing system 112 may include a network interface device 120 (e.g., a wireless local area network (WLAN) radio, a cellular radio, a Bluetooth® radio, a satellite radio, a Universal Serial Bus (USB) controller, etc.) that enables the computing system 112 (and hence, the vehicle 102) to communicate with entities 122 inside and/or outside of the vehicle 102 over a network 124. The entities 122 may be or include smartphone(s), desktop computing device(s), laptop computing device(s), tablet computing device(s), wearable computing device(s), extended reality (XR) computing device(s), gaming console(s), server computing device(s), cloud computing device(s), edge device(s), Internet-of-Things (IoT) device(s), RSU(s), and/or other vehicle(s). The network interface device 120 may also enable the computing system 112 (and hence, the vehicle 102) to communicate with a cloud computing platform 126. The cloud computing platform 126 may be associated with a manufacturer of the vehicle 102 and/or an organization which performs maintenance on the vehicle 102.

The network 124 may be a public network (e.g., the Internet), a private network (e.g., a local area network (LAN) or wide area network (WAN)), or a combination thereof. In one example, the network 124 may include a wired and/or a wireless infrastructure, which may be provided by one or more wireless communications systems, such as a WiFi™ hotspot connected with the network 124 and/or a wireless carrier system that can be implemented using various data processing equipment, communication towers (e.g., cell towers), etc. The network 124 may carry communications (e.g., data, messages, packets, frames, etc.) between computing devices.

It is to be understood that the computing system 112 and/or the vehicle 102 may include elements not depicted in FIG. 1, such as storage devices (e.g., a hard-disk drive (HDD), a solid-state drive (SSD), etc.) and/or other hardware devices (e.g., a sound card, etc.). A storage device may include a persistent storage that is capable of storing data. A persistent storage may be a local storage unit or a remote storage unit. Persistent storage may be a magnetic storage unit, an optical storage unit, a solid state storage unit, electronic storage units (main memory), or a similar storage unit. Persistent storage may also be a monolithic/single device and/or a distributed set of devices.

The memory 116 may include security risk levels 128. A security risk level may alternatively be referred to as “a safety level” or “a security/safety level.” In an example, the vehicle 102 may be configured with the security risk levels 128 when the vehicle 102 is manufactured and/or when the vehicle 102 undergoes service. In some aspects, the cloud computing platform 126 may configure the vehicle 102 with the security risk levels 128 (or update the security risk levels 128) on a periodic basis (e.g., at night when the vehicle 102 is not in use).

A security risk level in the security risk levels 128 may be indicative of a level of a security threat to the vehicle 102. In an example, the security risk levels 128 may include level zero (no danger), level one (low danger), level two (medium danger), level three (high danger), and level four (critical danger). In an example, a relatively low safety level in the security risk levels 128 may be indicative of no threat or a lesser threat to the vehicle 102 (e.g., exposure of details of account information of an entertainment system of the vehicle) and a relatively high safety level may be indicative of a more serious threat to the vehicle 102 (e.g., a loss of control of a steering system of the vehicle 102).

It is contemplated that the vehicle 102 may operate in one of the security risk levels 128 at a given time. The vehicle 102 (via the computing system 112) may determine which security level in the security risk levels 128 that the vehicle 102 is to operate in based on a variety of factors. The variety of factors may be or include sensor data from the sensors 108, an environmental condition (e.g., the vehicle 102 entering a known danger area), communications received by/transmitted from the vehicle 102 (e.g., communications from the cloud computing platform 126 and/or a device in the entities 122), an analysis of communications received by/transmitted from the vehicle 102 (e.g., an analysis of packets received by the vehicle 102 from an entity in the entities 122, such as performing attack pattern matching through an extended Berkeley Packet Filtering (eBPF) command dataset), a functional safety (FuSa) rule, a current state of the vehicle 102 (e.g., whether the vehicle 102 is exhibiting abnormal behavior), and/or a user request from a driver of the vehicle 102.

The memory 116 may store a rule list 130. In an example, the vehicle 102 may receive the rule list 130 from the cloud computing platform 126 over the network 124. In another example, the vehicle 102 may be configured with the rule list 130 at a time of manufacture of the vehicle 102.

The rule list 130 may include a first security rule 132 and an Nth security rule 134, where N is a positive integer greater than one. The first security rule 132 and the Nth security rule 134 may be collectively referred to as a “plurality of security rules 132-134.” In general, a security rule in the plurality of security rules 132-134, when executed by the rules engine 118, may cause the vehicle 102 to determine a correct assessment of a security risk and a mitigation measure (e.g., based on a security risk level in the security risk levels 128). In general, a security rule in the plurality of security rules 132-134 may have a structure of “IF (attack or scenario) THEN (mitigation).”

The first security rule 132 may include an indication of a security risk 136 to the vehicle 102. In an example, the indication of the security risk 136 may be or include an ECU in the ECUs 104 that is vulnerable to an attack, an indication of a vehicle system in the vehicle systems 106 that is potentially able to be accessed remotely by an unauthorized user, an indication of a compromised safety system, an indication of a ransomware attack, an indication of data theft (e.g., location data, driving habits, personal preferences of a user of the vehicle 102, personal data of the user of the vehicle 102, a software bug, malware, a backdoor, a malicious mobile application installed on a mobile phone, etc.).

The first security rule 132 may include a mitigation strategy 138 for the security risk 136. In an example, the mitigation strategy 138 may be or include a generic identification of an ECU in the ECUs 104 that is at risk, an identification of a vehicle system in the vehicle systems 106 that is at risk, and/or an identification of a subsystem of the vehicle that is at risk (e.g., when there is no known countermeasure, but an anomaly shows an impact on a specific subsystem). In another example, the mitigation strategy 138 may be or include rate-limiting. Rate-limiting may refer to a technique to control the flow of requests to a system or an application by limiting a number of requests allowed within a specific timeframe. Rate-limiting may be used to prevent a denial-of-service (DoS) attack and/or a distributed denial-of-service (DDoS) attack on the vehicle 102 (i.e., on the computing system 112 of the vehicle 102). In yet another example, the mitigation strategy 138 may be or include verbose logging. Verbose logging may refer to a technique whereby a system records a high volume of detailed information about an event that may be used for debugging and/or troubleshooting. Verbose logging may enable insight into the structure of an attack on the vehicle 102. In a further example, the mitigation strategy 138 may be or include disabling an ECU in the ECUs 104, preventing an ECU in the ECUs 104 from receiving a software update, preventing an ECU in the ECUs 104 from communicating with other ECUs and/or other devices, disabling a feature of the ECU in the ECUs 104, and/or otherwise modifying functionality of an ECU in the ECUs 104.

In some aspects, the first security rule 132 may further include metadata 140 associated with a standard. In an example, the standard may be associated with functional safety (FuSa) and/or an automotive safety integrity level (ASIL). FuSa may be defined as the absence of unacceptable risk due to hazards caused by malfunctioning behavior of electrical and/or electronic systems of a vehicle. A goal of FuSa may be to prevent systematic design failures and to detect and control random hardware faults. FuSa may be related to an automotive safety integrity level (ASIL). ASIL may refer to a risk classification scheme that helps to define safety requirements. A malfunctioning resource of a vehicle may be identified by one of four ASIL levels: ASIL A (lowest hazard), ASIL B, ASIL C, or ASIL D (highest hazard). An ASIL level of a resource (e.g., a vehicle system or an ECU) may be based on a severity of the failure of the resource, a likelihood of the failure occurring, and how much time the vehicle 102 is exposed to the failure of the resource. In a specific example, the standard may be related to the International Organization for Standardization (ISO) 26262 Definitions of Severity and Controllability. The rules engine 118 may utilize the metadata 140 to determine that the first security rule 132 conforms to the standard.

In some aspects, the first security rule 132 may include a flag 142 that indicates that the first security rule 132 has a limited timeframe (e.g., several seconds, several minutes, etc.) for execution from a time at which a security threat is identified. If the rules engine 118 does not complete execution of the first security rule 132 (e.g., by implementing the mitigation strategy 138 indicated by the first security rule 132) within the limited time frame, the rules engine 118 may re-evaluate the first security rule 132 before completing execution of the first security rule 132. Re-evaluating the first security rule 132 may include determining that the security risk 136 is still present before implementing the mitigation strategy 138. In an example, if the mitigation strategy 138 includes turning off an engine of the vehicle 102, but the vehicle 102 is currently in motion at an end of the limited timeframe, the vehicle 102 may re-evaluate the first security rule 132.

The Nth security rule 134 may include an indication of a security risk (not depicted in FIG. 1) and a mitigation strategy (not depicted in FIG. 1). The indication of the security risk included in the Nth security rule 134 may be different from the indication of the security risk 136 included in the first security rule 132. The mitigation strategy included in the Nth security rule 134 may be the same as or different from the mitigation strategy included in the first security rule 132. In some aspects, the Nth security rule 134 may also include metadata (e.g., metadata similar or identical to the metadata 140) and a flag (e.g., a flag similar or identical to the flag 142).

In an example, the vehicle 102 may obtain a security risk indication 144. In an example, obtaining the security risk indication 144 may include determining a security risk based on the sensor data 110 and/or a communication 145 received by the vehicle 102 from an entity in the entities 122. In another example, obtaining the security risk indication 144 may include receiving the security risk indication 144 from the cloud computing platform 126 over the network 124.

The vehicle 102, via the rules engine 118, may identify a security rule (e.g., the first security rule 132) from amongst the plurality of security rules 132-134 based on the security risk indication 144. In some aspects, the security risk indication 144 may be similar or identical to the indication of the security risk 136 in the first security rule 132, and identifying the security rule may include executing a search over the plurality of security rules 132-134 based on the security risk indication 144 in order to match the security risk indication 144 to the indication of the security risk 136. In some other aspects, the security risk indication 144 may be in a different format than the indication of the security risk 136 in the first security rule 132, and the vehicle 102 may process the security risk indication 144 in order to identify the first security rule 132.

In some aspects, the vehicle 102, via the rules engine 118, may determine a security risk level in the security risk levels 128 based on the security risk indication 144. The vehicle 102, via the rules engine 118, may identify the first security rule 132 additionally based on the determined security risk level in the security risk levels 128.

In some aspects, the memory 116 may include indications of triggering events 146. In such aspects, the rules engine 118 may detect a triggering event in the triggering events 146 and the rules engine 118 may identify the first security rule 132 (or another security rule) additionally based on the detection of the triggering event. In an example, the triggering events 146 may be or include a system-defined amount of time elapsing, a user-defined amount of time elapsing, the vehicle 102 being located at a defined geolocation (e.g., a geolocation known to be associated with security threats), the vehicle 102 undergoing service, and/or a user-initiated request.

Upon identifying the first security rule 132 (or another security rule in the plurality of security rules 132-134), the vehicle 102 may implement the mitigation strategy 138 (or another mitigation strategy) at the vehicle 102. For instance, the vehicle 102 may identify an ECU of the vehicle, identify a vehicle system of the vehicle 102, identifying a subsystem of the vehicle 102, perform rate-limiting with respect to communications of the vehicle 102, perform verbose logging, modify functionality of an ECU of the vehicle 102, prevent an ECU of the vehicle 102 from communicating, and/or disable an ECU of the vehicle 102. In some aspects, the vehicle 102 may implement the mitigation strategy 138 in view of the metadata 140 and/or the flag 142 indicated by the first security rule 132. For instance, the vehicle 102 may wait to implement the mitigation strategy 138 until the vehicle 102 is at rest.

In some aspects, the rules engine 118 may maintain an audit log 148 in the memory 116 that may be utilized to provide evidence of actions taken by the vehicle 102 for security and/or auditing purposes. Upon implementing the identified the first security rule 132 (or another security rule in the plurality of security rules 132-134) and/or upon implementing the mitigation strategy 138 (or another mitigation strategy), the rules engine 118 may generate an entry 150 in the audit log 148.

The entry 150 may include a timestamp 152 corresponding to a date and time at which the first security rule 132 was identified and/or a date and time at which the mitigation strategy 138 was implemented. The entry 150 may further include a snapshot 154 of operational metrics of the vehicle 102 corresponding to the timestamp 152. In an example, the snapshot 154 may be or include a speed of the vehicle 102, a velocity of the vehicle 102, an orientation of the vehicle 102, a location of the vehicle 102 (e.g., latitude and longitude coordinates, a street address, etc.), a state of one or more of the vehicle systems 106, logs of communications received by and/or transmitted from the vehicle 102, etc. The entry 150 may also include an indication of a security rule 156 (e.g., the first security rule 132) that was executed by the rules engine 118. In some aspects, the vehicle 102 may transmit the audit log 148 and/or the entry 150 to the cloud computing platform 126 over the network 124.

The vehicle 102 may also receive an update 131 to the rule list 130 from the cloud computing platform 126 over the network 124. In an example, the update 131 may include a change to the indication of the security risk 136, the mitigation strategy 138, the metadata 140, and/or the flag 142. The vehicle 102 may identify a security rule in the plurality of security rules 132-134 and/or implement a mitigation strategy based on the update 131 to the rule list 130.

Cars and other vehicles may adopt technology that makes the cars and other vehicles equivalent to a computer from a certain point of view. Cars and other vehicles may be constantly exposed to potential attacks. Aspects presented herein pertain to multiple security defense levels in an automotive context. In particular, some aspects presented herein pertain to protecting vehicle functionality by excluding some ECUs related to particular functionality of a vehicle.

As discussed above, automotive vehicles may be seen as computers exposed to the whole physical world, including the Internet. As such, automotive vehicles may be at risk of being attacked or abused. Some aspects presented herein pertain to introducing intrinsic security mechanisms (e.g., at an automotive software level) to limit damage when an incident (e.g., a security incident) occurs.

Some aspects presented herein pertain to an ability of a vehicle to automatically detect situations where the vehicle should change a security level by invoking a system to mitigate security risks. As described herein, a vehicle may determine that the vehicle is under attack by monitoring physical signals and/or virtual signals. Security attack mitigation for automotive dynamic security defense levels as described herein may be based on sensor sourcing and/or pattern detection and mitigation.

In some aspects, when a vehicle determines that the vehicle is under attack, the vehicle may escalate (i.e., increase) a security level of the vehicle, particularly when a target of the attack is an ECU and/or a related sensor. In some aspects, the vehicle may be able to detect an attack through extended Berkeley Packet Filter (eBPF) tools applied to an ECU of the vehicle.

Once the vehicle detects and/or identifies an attack, the vehicle may evaluate a level of the attack based on rules defined in a rules engine. A rules engine may refer to software (i.e., computer-executable instructions) that evaluates a set of rules and takes action based on the evaluated set of rules. In an example, an indication of the attack may be provided to the rules engine and the rules engine may assess a security risk and determine a mitigation measure based on the indication of the attack.

In an example, a rule in the rules engine may have a general structure of “IF (attack or scenario), THEN (mitigation).” Mitigation may be or include a generic identification of an ECU and/or a subsystem at risk (e.g., when there is no known countermeasure, but an anomaly shows an impact on a specific subsystem). Mitigation may be or include rate-limiting. Mitigation may be or include verbose logging. Mitigation may be or include a granular countermeasure (e.g., disabling a system update for a specific ECU).

In some aspects, the rules may be included in a rules list that may be updated by a manufacturer of the vehicle at any time during a life of the vehicle (e.g., when the vehicle is serviced or when the vehicle is connected to a network such as the Internet). In an example, if a particular manufacturer knows about a particular weakness of vehicle ECU software, the particular manufacturer may set an ECU exclusion at a level where an attack will be (and/or will likely be) detected. Once the software is updated and patched, an ECU exclusion list that indicates the ECU exclusion may be updated again.

In some aspects, rule evaluation of a rule by the rules engine may be triggered by controlled events. The controlled events may be or include after a user-defined amount of time elapses, after a system-defined amount of time elapses, after an update of the vehicle, the vehicle entering a defined geolocation (e.g., after or before entering specific areas), on-demand during service, and/or on-demand by a request of a user.

In some aspects, the rules of the rules engine may have implicit support for asynchronous requests. For example, a rule may include a flag that specifies that a rule execution of the rule has a limited time span and that the rule is to be re-evaluated when the limited time span expires. For example, a vehicle that is performing a specific task may not be able to immediately transition to a different state due to the risk of deactivating FuSa relevant features. For instance, a vehicle may not be able to turn off an engine of the vehicle if the vehicle is currently in motion.

In some aspects, the rules may include additional metadata that enables the rules to be classified to adherence to FuSa specifications. For example, the metadata may be or include an automotive safety integrity level (ASIL) classification and/or the metadata may be associated with the International Organization for Standardization (ISO) 26262 definitions of severity and controllability.

In some aspects, the rules engine may be responsible for producing a complete audit of execution of the rules engine that may be paired with regular snapshots of system metrics of the vehicle in order to provide evidence of actions of the rules engine. The evidence of the actions may be used both for security and auditing purposes.

The technologies described herein may be associated with various advantages. The advantages may include protecting vehicle ECUs from being compromised. The advantages may also include helping to distinguish between security levels of a vehicle when the vehicle is at rest and when the vehicle is in transit.

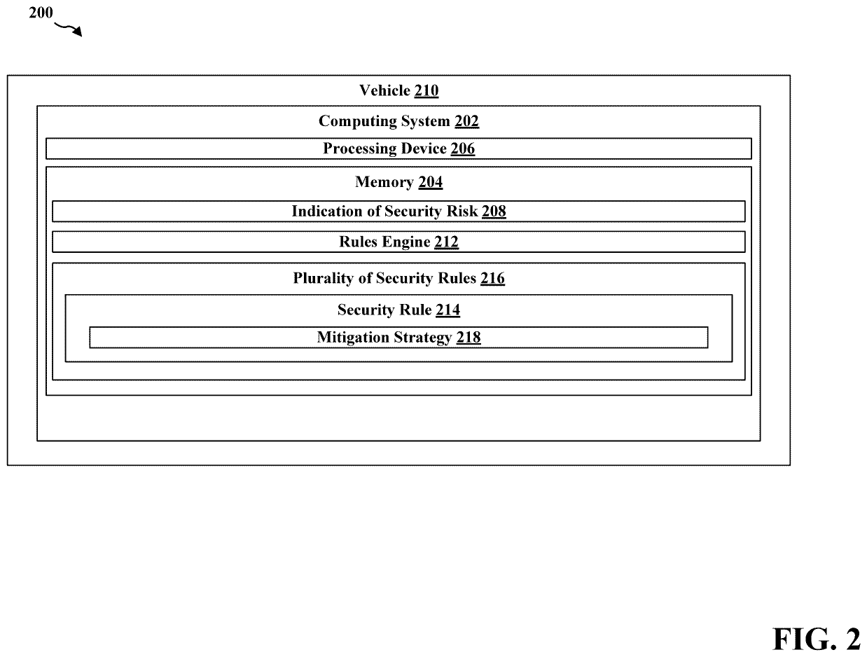

FIG. 2 is a block diagram 200 that illustrates an example system in accordance with some aspects of the present disclosure. The system includes a computing system 202. The computing system 202 includes a memory 204 and a processing device 206. The processing device 206 is operatively coupled to the memory 204 to: obtain an indication of a security risk 208 to a vehicle 210; identify, via a rules engine 212, a security rule 214 from amongst a plurality of security rules 216 based on the indication of the security risk 208 to the vehicle 210, wherein the security rule 214 indicates a mitigation strategy 218 for the security risk; and implement, at the vehicle 210, the mitigation strategy 218 indicated by the security rule 214.

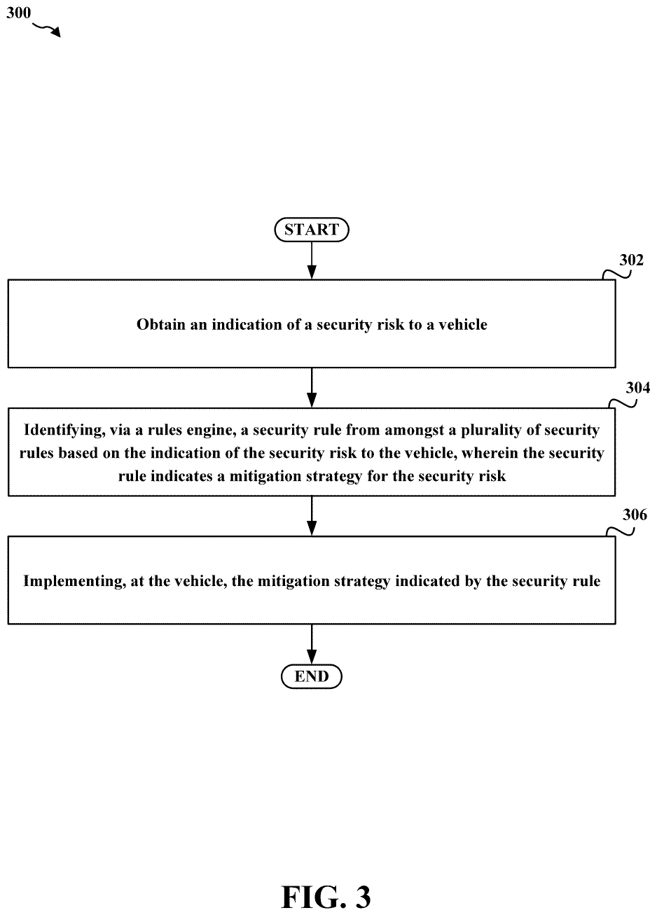

FIG. 3 is a flow diagram of a method 300 for security attack mitigation for automotive dynamic security defense levels in accordance with some aspects of the present disclosure. The method 300 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some aspects, the method 300 may be performed by the vehicle 102, the computing system 112, the processing device 114, the vehicle 210, the computing system 202, the processing device 206, the computer system 400, and/or the processing device 402.

At block 302, processing logic obtains an indication of a security risk to a vehicle. In an example, the indication of the security risk may be or include the security risk indication 144. In an example, the vehicle may be or include the vehicle 102. In another example, the indication of the security risk to the vehicle may be or include the indication of the security risk 208 and the vehicle may be or include the vehicle 210.

At block 304, the processing logic identifies, via a rules engine, a security rule from amongst a plurality of security rules based on the indication of the security risk to the vehicle, where the security rule indicates a mitigation strategy for the security risk. In an example, the rules engine may be or include the rules engine 118, the security rule may be or include the first security rule 132, the plurality of security rules may be or include the plurality of security rules 132-134, and the mitigation strategy may be or include the mitigation strategy 138. In another example, the rules engine may be or include the rules engine 212, the security rule may be or include the security rule 214, the plurality of security rules may be or include the plurality of security rules 216, and the mitigation strategy may be or include the mitigation strategy 218.

At block 306, the processing logic implements, at the vehicle, the mitigation strategy indicated by the security rule. For example, the vehicle 102 may implement the mitigation strategy 138. In another example, the vehicle 210 may implement the mitigation strategy 218.

In some aspects, the security rule may include the indication of the security risk. In an example, the first security rule 132 may include an indication of the security risk 136 which may be similar or identical to the security risk indication 144.

In some aspects, the processing logic may determine, via the rules engine, a level of the security risk based on the indication of the security risk to the vehicle, where identifying the security rule may be further based on the level of the security risk. In an example, the level of the security risk may be a security risk level in the security risk levels 128, and identifying the first security rule 132 may be based on the security risk level in the security risk levels 128.

In some aspects, obtaining the indication of the security risk to the vehicle may include determining the security risk to the vehicle based on at least one of sensor data of the vehicle or a communication received by the vehicle. In an example, obtaining the security risk indication 144 may include determine a security risk to the vehicle 102 based on the sensor data 110 and/or the communication 145.

In some aspects, obtaining the indication of the security risk to the vehicle may include receiving, over a network, the indication of the security risk to the vehicle. In an example, obtaining the security risk indication 144 may include receiving, over the network 124, the security risk indication 144 (e.g., from the cloud computing platform 126).

In some aspects, the mitigation strategy may include at least one of: identifying an electronic control unit (ECU) of the vehicle, identifying a subsystem of the vehicle, performing rate-limiting with respect to communications of the vehicle, performing verbose logging, modifying functionality of the ECU of the vehicle, or disabling the ECU of the vehicle. In an example, the mitigation strategy 138 may be or include identifying an ECU (from the ECUs 104) of the vehicle 102, identifying a subsystem of the vehicle 102, performing rate-limiting with respect to communications of the vehicle 102, performing verbose logging, modifying functionality of the ECU of the vehicle, and/or disabling the ECU of the vehicle 102.

In some aspects, the processing logic may detect a triggering event associated with the rules engine, where identifying the security rule from amongst the plurality of security rules may be based on the detected triggering event. For example, the triggering event may be or include a triggering event in the triggering events 146, and identifying the first security rule 132 may be based on the triggering event in the triggering events 146.

In some aspects, the triggering event may include at least one of: a system-defined amount of time elapsing, a user-defined amount of time elapsing, the vehicle being located at a defined geolocation, the vehicle undergoing service, or a user-initiated request. For example, the triggering event in the triggering events 146 may be or include a system-defined amount of time elapsing, a user-defined amount of time elapsing, the vehicle 102 being located at a defined geolocation, the vehicle 102 undergoing service, and/or a user-initiated request.

In some aspects, the security rule may indicate metadata associated with a functional safety (FuSa) standard, and implementing the mitigation strategy may be additionally based on the metadata indicated by the security rule. For example, the metadata may be or include the metadata 140, and implementing the mitigation strategy 138 may be additionally based on the metadata 140.

In some aspects, the processing logic may generate, by the rules engine, an entry in an audit log, where the entry may indicate at least one of the identified security rule or the implemented mitigation strategy. In an example, the entry may be or include the entry 150, the audit log may be or include the audit log 148, the identified security rule may be or include the first security rule 132, and the implemented mitigation strategy may be or include the mitigation strategy 138.

In some aspects, the processing logic may generate a snapshot of operational metrics of the vehicle at a time instance corresponding to at least one of identification of the security rule or implementation of the security rule. In an example, the snapshot may be or include the snapshot 154.

In some aspects, the processing logic may add the snapshot to the entry in the audit log. For example, the vehicle 102 may add the snapshot 154 to the entry 150 in the audit log 148.

In some aspects, the processing logic may receive, over a network, the plurality of security rules. For example, the vehicle 102 may receive the rule list 130 over the network 124, where the rule list 130 includes the plurality of security rules 132-134.

In some aspects, the processing logic may receive an update to the plurality of security rules, where identifying the security rule may be based on the update to the plurality of security rules. For example, the update may be or include the update 131, and identifying the first security rule 132 may be based on the update 131.

In some aspects, the vehicle may include at least one of: a land vehicle, a sea vehicle, or an air vehicle. For example, the vehicle 102 may be or include a land vehicle, a sea vehicle, and/or an air vehicle.

In some aspects, the security rule may include a flag indicating that the security rule is associated with a time span, and wherein implementing the mitigation strategy may include implementing the mitigation strategy within the time span from a time at which the indication of the security risk is obtained. For example, the flag may be or include the flag 142.

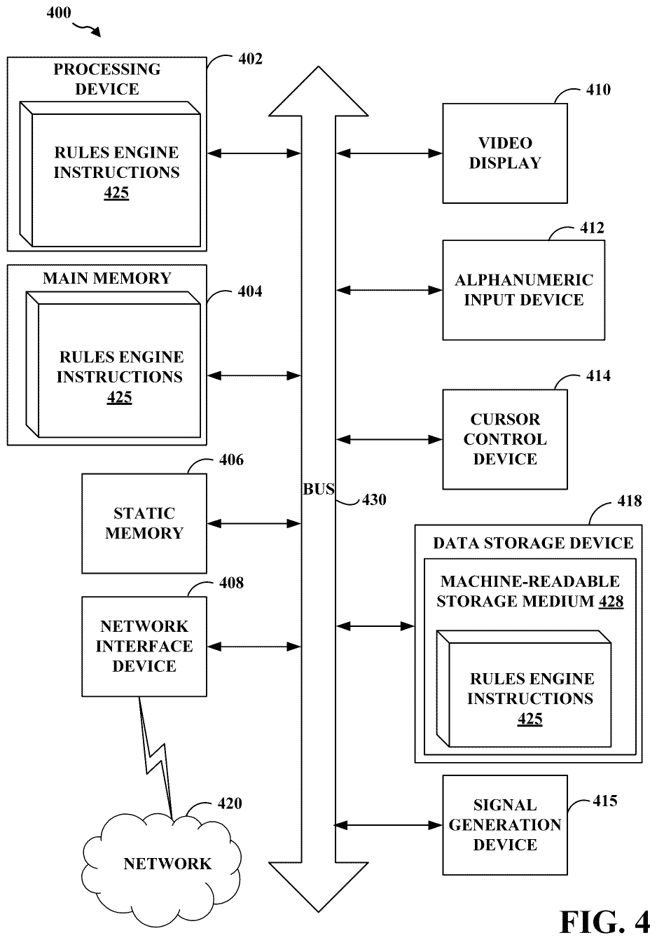

FIG. 4 illustrates a diagrammatic representation of a machine in the example form of a computer system 400 within which a set of instructions, for causing the machine to perform any one or more of the methodologies discussed herein for security attack mitigation for automotive dynamic security defense levels. More specifically, the machine may obtain an indication of a security risk to a vehicle; identify, via a rules engine, a security rule from amongst a plurality of security rules based on the indication of the security risk to the vehicle, wherein the security rule indicates a mitigation strategy for the security risk; and implement, at the vehicle, the mitigation strategy indicated by the security rule.

In alternative aspects, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or a bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one aspect, the computer system 400 may be representative of a server.

The computer system 400 includes a processing device 402, a main memory 404 (e.g., read-only memory (ROM), flash memory, dynamic random access memory (DRAM), a static memory 406 (e.g., flash memory, static random access memory (SRAM), etc.), and a data storage device 418, which communicate with each other via a bus 430. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 400 may further include a network interface device 408 which may communicate with a network 420. The computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 415 (e.g., a speaker). In one example, the video display unit 410, the alphanumeric input device 412, and the cursor control device 414 may be combined into a single component or device (e.g., an LCD touch screen).

The processing device 402 represents one or more general-purpose processing devices such as a microprocessor, a central processing unit, or the like. More particularly, the processing device 402 may be a complex instruction set computing (CISC) microprocessor, a reduced instruction set computer (RISC) microprocessor, a very long instruction word (VLIW) microprocessor, or a processor implementing other instruction sets, or processors implementing a combination of instruction sets. The processing device 402 may also be one or more special-purpose processing devices such as an application specific integrated circuit (ASIC), a field programmable gate array (FPGA), a digital signal processor (DSP), a network processor, or the like. The processing device 402 is configured with rules engine instructions 425, for performing the operations and steps discussed herein. For example, the rules engine instructions 425 may include instructions for obtaining an indication of a security risk to a vehicle; identifying, via a rules engine, a security rule from amongst a plurality of security rules based on the indication of the security risk to the vehicle, where the security rule indicates a mitigation strategy for the security risk; and implementing, at the vehicle, the mitigation strategy indicated by the security rule.

The data storage device 418 may include a machine-readable storage medium 428 (e.g., a non-transitory computer-readable medium) storing rules engine instructions 425 (e.g., software) thereon embodying any one or more of the methodologies of functions described herein. The rules engine instructions 425 may also reside, completely or partially, within the main memory 404 or within the processing device 402 during execution thereof by the computer system 400; the main memory 404 and the processing device 402 also constituting machine-readable storage media. The rules engine instructions 425 may further be transmitted or received over the network 420 via the network interface device 408.

The machine-readable storage medium 428 may also be used to store the rules engine instructions 425 to perform a method for security attack mitigation for automotive dynamic security defense levels, as described herein. While the machine-readable storage medium 428 is shown in an exemplary aspect to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, a magnetic storage medium (e.g., floppy diskette), an optical storage medium (e.g., CD-ROM), a magneto-optical storage medium, a read-only memory (ROM), random-access memory (RAM), erasable programmable memory (e.g., EPROM and EEPROM), flash memory, or another type of medium suitable for storing electronic instructions.

The preceding description sets forth numerous specific details such as examples of specific systems, components, methods, and so forth, in order to provide a good understanding of several aspects of the present disclosure. It will be apparent to one skilled in the art, however, that at least some aspects of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular aspects may vary from these exemplary details and still be contemplated to be within the scope of the present disclosure.

Additionally, some aspects may be practiced in distributed computing environments where the machine-readable medium is stored on and or executed by more than one computer system. In addition, the information transferred between computer systems may either be pulled or pushed across the communication medium connecting the computer systems.

Aspects of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another aspect, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” or “an implementation” or “one implementation” throughout is not intended to mean the same aspect or implementation unless described as such. Furthermore, the terms “first,” “second,” “third,” “fourth,” etc. as used herein are meant as labels to distinguish among different elements and may not necessarily have an ordinal meaning according to their numerical designation. Unless specifically stated otherwise, terms such as “obtaining,” “identifying,” “implementing,” “determining,” “performing,” “modifying,” “disabling,” “enabling,” “detecting,” “generating,” “adding,” “receiving,” “transmitting,” “inputting,” “outputting,” “selecting,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass aspects in hardware, software, or a combination thereof.

What is claimed is:

1. A method, comprising:
obtaining an indication of a security risk to a vehicle;
identifying, via a rules engine executed by a processing device, a security rule from amongst a plurality of security rules based on the indication of the security risk to the vehicle, wherein the security rule indicates a mitigation strategy for the security risk; and
implementing, at the vehicle, the mitigation strategy indicated by the security rule.

2. The method of claim 1, wherein the security rule comprises the indication of the security risk.

3. The method of claim 1, further comprising:
determining, via the rules engine, a level of the security risk based on the indication of the security risk to the vehicle, wherein identifying the security rule is further based on the level of the security risk.

4. The method of claim 1, wherein obtaining the indication of the security risk to the vehicle comprises determining the security risk to the vehicle based on at least one of sensor data of the vehicle or a communication received by the vehicle.

5. The method of claim 1, wherein obtaining the indication of the security risk to the vehicle comprises receiving, over a network, the indication of the security risk to the vehicle.

6. The method of claim 1, wherein the mitigation strategy includes at least one of:
identifying an electronic control unit (ECU) of the vehicle,
identifying a subsystem of the vehicle,
performing rate-limiting with respect to communications of the vehicle,
performing verbose logging,
modifying functionality of the ECU of the vehicle, or
disabling the ECU of the vehicle.

7. The method of claim 1, further comprising:
detecting a triggering event associated with the rules engine, wherein identifying the security rule from amongst the plurality of security rules is additionally based on the detected triggering event.

8. The method of claim 7, wherein the triggering event includes at least one of:
a system-defined amount of time elapsing,
a user-defined amount of time elapsing,
the vehicle being located at a defined geolocation,
the vehicle undergoing service, or
a user-initiated request.

9. The method of claim 1, wherein the security rule indicates metadata associated with a functional safety (FuSa) standard, and wherein implementing the mitigation strategy is additionally based on the metadata indicated by the security rule.

10. The method of claim 1, further comprising:
generating, by the rules engine, an entry in an audit log, wherein the entry indicates at least one of the identified security rule or the implemented mitigation strategy.

11. The method of claim 10, further comprising:
generating a snapshot of operational metrics of the vehicle at a time instance corresponding to at least one of identification of the security rule or implementation of the security rule; and
adding the snapshot to the entry in the audit log.

12. The method of claim 1, further comprising:
receiving, over a network, the plurality of security rules.

13. The method of claim 12, further comprising:
receiving an update to the plurality of security rules, wherein identifying the security rule is based on the update to the plurality of security rules.

14. The method of claim 1, wherein the vehicle comprises at least one of:
a land vehicle,
a sea vehicle, or
an air vehicle.

15. The method of claim 1, wherein the security rule includes a flag indicating that the security rule is associated with a time span, and wherein implementing the mitigation strategy comprises implementing the mitigation strategy within the time span from a time at which the security rule is identified.

16. A system, comprising:
a memory; and
a processing device, operatively coupled to the memory, to:
obtain an indication of a security risk to a vehicle;
identify, via a rules engine, a security rule from amongst a plurality of security rules based on the indication of the security risk to the vehicle, wherein the security rule indicates a mitigation strategy for the security risk; and
implement, at the vehicle, the mitigation strategy indicated by the security rule.

17. The system of claim 16, wherein the mitigation strategy includes at least one of:
identifying an electronic control unit (ECU) of the vehicle,
identifying a subsystem of the vehicle,
performing rate-limiting with respect to communications of the vehicle,
performing verbose logging,
modifying functionality of the ECU of the vehicle, or
disabling the ECU of the vehicle.

18. The system of claim 16, wherein the processing device is further to:
detect a triggering event associated with the rules engine, wherein to identify the security rule from amongst the plurality of security rules, the processing device is to identify the security rule from amongst the plurality of security rules additionally based on the detected triggering event.

19. A non-transitory computer-readable medium having instructions stored thereon which, when executed by a processing device, cause the processing device to:
obtain an indication of a security risk to a vehicle;
identify, via a rules engine executed by the processing device, a security rule from amongst a plurality of security rules based on the indication of the security risk to the vehicle, wherein the security rule indicates a mitigation strategy for the security risk; and
implement, at the vehicle, the mitigation strategy indicated by the security rule.

20. The non-transitory computer-readable medium of claim 19, wherein the mitigation strategy includes at least one of:
identifying an electronic control unit (ECU) of the vehicle,
identifying a subsystem of the vehicle,
performing rate-limiting with respect to communications of the vehicle,
performing verbose logging,
modifying functionality of the ECU of the vehicle, or
disabling the ECU of the vehicle.
